(19) United States
(12) Patent Application Publication
(10) Pub. No.: US 2026/0176915 A1
(43) Pub. Date: Jun. 25, 2026

(54) PET DOOR WITH LOCKING MECHANISMS AND METHOD FOR CONTROLLING PET DOOR

(71) Applicant: NINGBO ACE GREENIS SMART TECH Co,.LTD, Ningbo (CN)

(72) Inventors: Yanbei QIN, Ningbo (CN); Wanni QIN, Ningbo (CN)

(73) Assignee: NINGBO ACE GREENIS SMART TECH Co,.LTD, Ningbo (CN)

(21) Appl. No.: 19/369,186

(22) Filed: Oct. 25, 2025

(30) Foreign Application Priority Data
Dec. 25, 2024 (CN) 2024119246011
Dec. 25, 2024 (CN) 2024232173681
Dec. 25, 2024 (CN) 2024232193416

(51) Int. Cl. E06B 7/32; E05B 47/00; E05B 65/06; E06B 3/38; G06V 40/10

(52) U.S. Cl. CPC E06B 7/32; E05B 47/00; E05B 65/06; E06B 3/38; G06V 40/10; E05B 2047/005

(57) ABSTRACT

The present invention provides a pet door with locking mechanisms and a method for controlling the pet door, and belongs to the technical field of pet management. The pet door with the locking mechanisms includes: a door frame including an inner portion and an outer portion, wherein the door frame is provided with a locking hole; a door body including a rotating side and a limiting side; a first locking mechanism arranged on the door frame and located between the inner portion and the door body, wherein the first locking mechanism includes a locking base and a locking pin, and the locking pin is extendable out of or retractable into the locking hole; and a second locking mechanism arranged on the door frame and located between the outer portion and the door body, wherein the second locking mechanism has a structure the same as that of the first locking mechanism.

### CROSS-REFERENCE TO RELATED APPLICATIONS

The application claims priority to Chinese patent application No. CN2024232193416, filed on Dec. 25, 2024, and Chinese patent application No. CN2024232173681, filed on December 25, 2024,and Chinese patent application No. CN 024119246011, filed on Dec. 25, 2024, the entire contents of which are incorporated herein by reference.

### TECHNICAL FIELD

The present invention belongs to the technical field of pet management, and relates to a pet door, in particular to a pet door with locking mechanisms and a method for controlling the pet door.

### BACKGROUND

### Description of Related Art

Nowadays, many people keep pets, some out of hobbies, and others for companionship. Pets not only need food, water, and shelter, but also often require entertainment and outdoor activities. This is especially true for more active pets. However, it would be troublesome to constantly open and close the door for pets. Hence, there emerge pet doors on the market.

For example, a utility model patent with Application Number CN202221964085.1 provides a door body with a pet door, including a door body and a pet door. The door body is provided with a cavity; a first shaft is transversely arranged in the cavity; the pet door is rotationally connected and installed on the cavity via the first shaft; the lower outer wall of the pet door is in sliding contact with the cavity, and the upper outer wall of the pet door is in sliding contact with the cavity; a swing reduction structure is arranged on either side of the cavity; each swing reduction structure includes a roller, a weight, and a support; the door body is provided with a first extension on either side above the cavity; each first extension is provided with a limiting ring; the supports are vertically and slidably connected to the limiting rings; the weights are fixedly arranged above the supports; the door body is provided with a second extension above the weights; the second extension is provided with a soft touch button above the weights; the door body is provided with an electric bell; the rollers are rotationally connected to the lower parts of the supports; a third extension is arranged on either upper side of the pet door; each third extension is provided with an upward inclined surface towards the outer side; the rollers are butted against the inclined surfaces; and when the pet door is opened, the inclined surfaces push the swing structures to move upwards.

In some existing technical solutions, the opening and closing of a pet door is conducted passively and is solely under the dominance of a pet, such that the open or closed state of the pet door cannot be locked, and the entry of outside pets and the escape of pets from home cannot be restricted, thus leaving significant room for improvement.

### SUMMARY

In view of the aforesaid problems existing in the prior art, an object of the present invention is to provide a pet door with locking mechanisms and a method for controlling the pet door.

The object of the present invention can be achieved by means of the following technical solution: a pet door with locking mechanisms, including:
a door frame including an inner portion, wherein the door frame is provided with a locking hole;
a door body including a rotating side and a limiting side, wherein the door body is rotatably connected to the door frame via the rotating side and is rotatable towards the inner portion, and the locking hole is located between inner portion and the door body;
a first locking mechanism arranged on the door frame and located between the inner portion and the door body, wherein the first locking mechanism includes a locking base and a locking pin, the locking base is located in the door frame and is liftable relative to the door frame, and the locking pin is connected to the locking base and is extendable out of or retractable into the locking hole;
when the locking pin extends out of the locking hole, the locking pin can come into contact with the limiting side to restrict rotation of the door body towards the inner portion; and when the locking pin retracts into the locking hole, the door body can freely rotate towards the inner portion.

In the pet door with the locking mechanisms as described above, the first locking mechanism further includes a drive element; the drive element is connected to the door frame; the locking base is connected to the drive element; and the drive element can drive lifting of the locking base.

In the pet door with the locking mechanisms as described above, the first locking mechanism further includes a reset spring; the reset spring has one end in contact with the door frame and the other end in contact with the locking base; and the reset spring pushes the locking base and drives the locking pin to extend out of the locking hole.

In the pet door with the locking mechanisms as described above, the locking base is provided with a pressing plate; the drive element includes a rotation shaft and an eccentric wheel; the rotation shaft is fixed relative to the door frame and is rotatable around a rotation axis thereof; the eccentric wheel is connected to the rotation shaft; a bottom portion of the eccentric wheel is in contact with the pressing plate; and the pressing plate is located between the eccentric wheel and the reset spring.

In the pet door with the locking mechanisms as described above, the drive element further includes a motor; the motor is connected to the door frame; the rotation shaft is connected to an output shaft of the motor; and the motor can drive rotation of the rotation shaft.

In the pet door with the locking mechanisms as described above, the drive element further includes an electric cylinder; the electric cylinder is connected to the door frame; the locking base is connected to an output shaft of the electric cylinder; and the electric cylinder can drive lifting of the locking base.

In the pet door with the locking mechanisms as described above, the door frame is further provided with a guide post; the locking base is provided with a guide hole; and the guide post is slidably connected to the guide hole to enable the locking base to be liftably connected to the door frame.

In the pet door with the locking mechanisms as described above, the guide post is provided with a limiting block; the locking base is further provided with a limiting slot; the limiting slot is communicated to the guide hole; and the limiting block is located in the limiting slot and is movable in a length direction of the limiting slot.

In the pet door with the locking mechanisms as described above, the door frame further includes an outer portion; the door body is located between the inner portion and the outer portion; and the door body is rotatable towards the inner portion or the outer portion.

In the pet door with the locking mechanisms as described above, the pet door further includes a second locking mechanism arranged on the door frame and located between the outer portion and the door body, wherein the second locking mechanism has a structure the same as that of the first locking mechanism;
when a locking pin of the second locking mechanism extends out of a locking hole, the locking pin of the second locking mechanism may come into contact with the limiting side to restrict rotation of the door body towards the outer portion; and when the locking pin of the second locking mechanism retracts into the locking hole, the door body may freely rotate towards the outer portion.

In the pet door with the locking mechanisms as described above, the pet door further includes a remote control system, wherein the remote control system is configured to be communicationally connected to a drive element of the second locking mechanism, and is configured for controlling operation of the drive element of the second locking mechanism.

In the pet door with the locking mechanisms as described above, the pet door further includes a pet face recognition system, wherein the pet face recognition system is connected to the door frame and located on the outer portion; and the pet face recognition system is communicationally connected to the drive element of the first locking mechanism, and is configured for recognizing a pet face to control operation of the drive element.

There is further provided a method for controlling a pet door, including the pet door with the locking mechanisms as described, wherein the method includes:
scheduling an access control period and a free period at the remote control system, wherein in the access control period, the remote control system automatically controls a motor of the second locking mechanism to cause the locking pin to extend out of the locking hole, thereby restricting rotation of the door body towards the outer portion, and in the free period, the remote control system automatically controls the motor of the second locking mechanism to cause the locking pin to retract into the locking hole, thereby allowing for free rotation of the door body towards the outer portion; and
performing temporary control at the remote control system to control the motor of the second locking mechanism to cause the locking pin to extend out of or retract into the locking hole.

In the method for controlling the pet door as described above, a pet face recognition system is further included; the pet face recognition system is connected to the door frame and located on the outer portion; the pet face recognition system is electrically connected to the motor, and is configured for recognizing a pet face to control operation of the motor; the pet face recognition system is communicationally connected to the remote control system; the remote control system is communicationally connected to the motor of the first locking mechanism, and is configured for controlling operation of the motor of the first locking mechanism; and
the method further includes:
registering a known pet face in the remote control system, and when the pet face recognition system recognizes an unfamiliar pet face, automatically controlling, by the pet face recognition system, the motor of the first locking mechanism to cause the locking pin to extend out of the locking hole to restrict rotation of the door body towards the inner portion; when the pet face recognition system recognizes the known pet face, automatically controlling, by the pet face recognition system, the motor of the first locking mechanism to cause the locking pin to retract into the locking hole to allow for free rotation of the door body towards the inner portion; and
performing temporary control at the remote control system to control the motor of the second locking mechanism to cause the locking pin to extend out of or retract into the locking hole.

Compared with the prior art, the present invention has the following advantageous effects.
1. The rotations of the door body towards the inner portion and the outer portion are restricted by the first locking mechanism and the second locking mechanism, respectively, and the extension or retraction of the locking pin out of or into the locking hole is controlled manually or automatically, such that the open or closed state of the pet door can be locked to restrict the entry of outside pets or the escape of pets from home.

12. The reset spring pushes the locking base and drives the locking pin to extend out of the locking hole. In this way, under normal circumstances, the locking pin can come into contact with the limiting side to restrict the rotation of the door body towards the inner portion or the outer portion, implementing safety protection to restrict the entry of outside pets or the escape of pets from home.
3. The pressing plate is located between the eccentric wheel and the reset spring. In this way, when pushing the locking base, the reset spring becomes tightly butted against the eccentric wheel, and rotates along with the rotation shaft around the axis of the rotation shaft to drive rotation of the eccentric wheel and cause the locking base to reciprocate linearly via the pressing plate, thereby allowing the locking pin to extend out of or retract into the locking hole.
4. The rotation shaft is fixedly connected to the output shaft of the motor and the motor can drive the rotation shaft to rotate, thereby achieving automatic control of the rotation shaft.
5. The locking of the opening and closing of the pet door towards the outer portion can be managed by presetting the access control period and the free period by means of the remote control system, and at the same time, the motor of the second locking mechanism can be temporarily controlled by means of the remote control system to cause the locking pin to extend out of or retract into the locking hole.
6. The locking of the opening and closing of the pet door towards the inner portion can be managed by means of the pet face recognition system.
7. The remote control system and the pet face recognition system are linked, such that the known pet face can be registered or deleted by means of the remote control system, thereby adjusting the pet face recognition system in real time. At the same time, the motor of the first locking mechanism can be temporarily controlled by means of the remote control system to cause the locking pin to extend out of or retract into the locking hole.

### BRIEF DESCRIPTION OF DRAWINGS

FIG. 1 is a schematic structural diagram of a pet door with locking mechanisms according to the present invention;

FIG. 2 is a schematic structural diagram of the pet door with the locking mechanisms according to the present invention from another point of view;

FIG. 3 is an exploded view of the pet door with the locking mechanisms according to the present invention;

FIG. 4 is an exploded view of the pet door with the locking mechanisms according to the present invention from another point of view;

FIG. 5 is a schematic structural diagram of a first locking mechanism and a second locking mechanism according to the present invention; and

FIG. 6 is an exploded view of the first locking mechanism and the second locking mechanism according to the present invention.

In the figures, reference signs are as follows: 100, door frame; 110, inner portion; 120, outer portion; 130, locking hole; 140, guide post; 141, limiting block; 200, door body; 210, rotating side; 220, limiting side; 300, first locking mechanism; 310, locking base; 311, pressing plate; 312, guide hole; 313, limiting slot; 320, locking pin; 330, reset spring; 340, rotating shaft; 350, eccentric wheel; 360, motor; 400, pet face recognition system; 500, second locking mechanism.

### DETAILED DESCRIPTION OF THE INVENTION

The following provides the specific embodiments of the present invention, and the technical solutions of the present invention will be further described below in conjunction with the accompanying drawings. However, the present invention is not limited to these embodiments.

It should be noted that all directional indications (such as, up, down, left, right, front, back, . . . ) in the embodiments of the present invention only serve to explain a relative positional relationship, a motion condition and the like between various components under a specific posture (as shown in the accompanying drawings). If the specific posture changes, the directional indications change therewith accordingly.

In addition, the descriptions such as “first”, “second” and “one” involved in the embodiments of the present invention are merely for a descriptive purpose, and shall not be construed as indicating or implying their relative importance or implicitly indicating the number of technical features indicated. As such, features defined by “first” and “second” can explicitly or implicitly include at least one of said features. In the description of the present invention, unless otherwise clearly specified, “a plurality of” means at least two, for example, two, three, etc.

In the present invention, unless otherwise expressly specified and defined, the terms “connection”, “fixation”, and the like should be understood in a broad sense. For example, the “fixation” may be a fixed connection, or a detachable connection or an integral connection; may be a mechanical connection or an electrical connection; may be a direct connection, or an indirect connection via an intermediate medium, or an internal connection between two elements, or an interaction relationship between two elements. For those of ordinary skill in the art, the specific meanings of the above terms in the present invention can be understood in accordance with specific conditions.

In addition, the technical solutions of various embodiments of the present invention can be combined with each other, which must be based on the fact that it is implementable for those skilled in the art. When the technical solutions are in conflict during the combining or the combination is not achievable, it should be considered that such a combination does not exist and is not within the protection scope claimed by the present invention.

The specific embodiments described herein are merely for exemplifying the spirit of the present invention. Those skilled in the art to which the present invention belongs may make a variety of modifications or supplementations or substitutions in a similar way to the specific embodiments as described, which is deemed as not departing from the spirit of the present invention or not going beyond the scope defined by the accompanying claims.

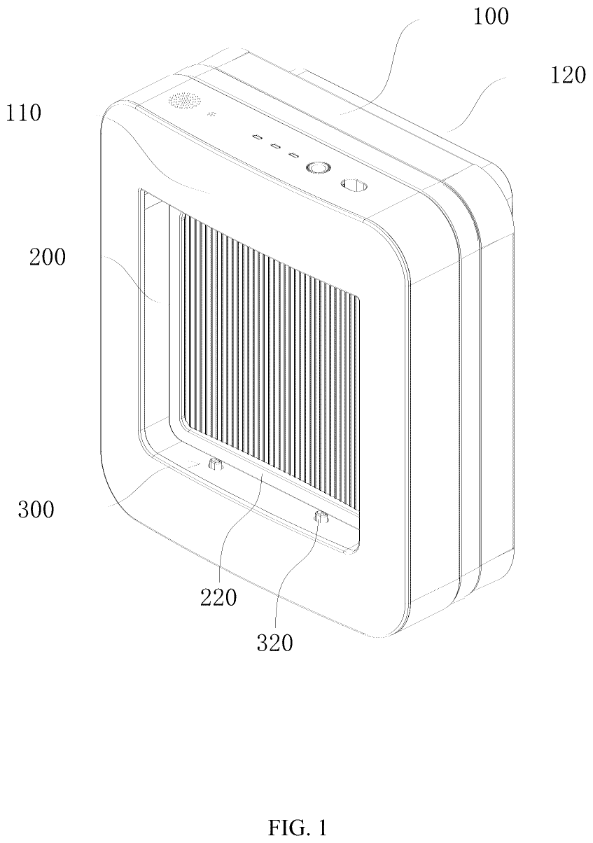

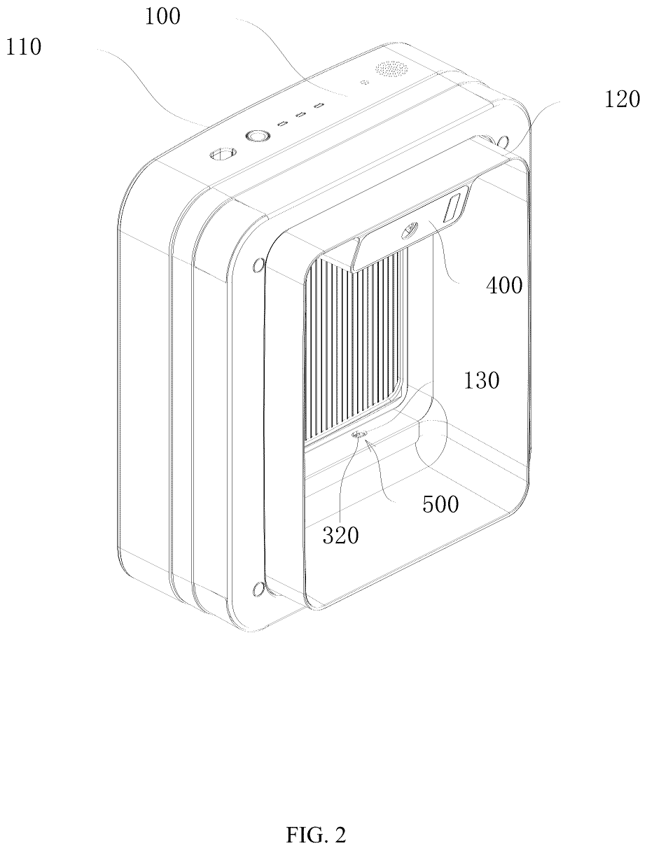

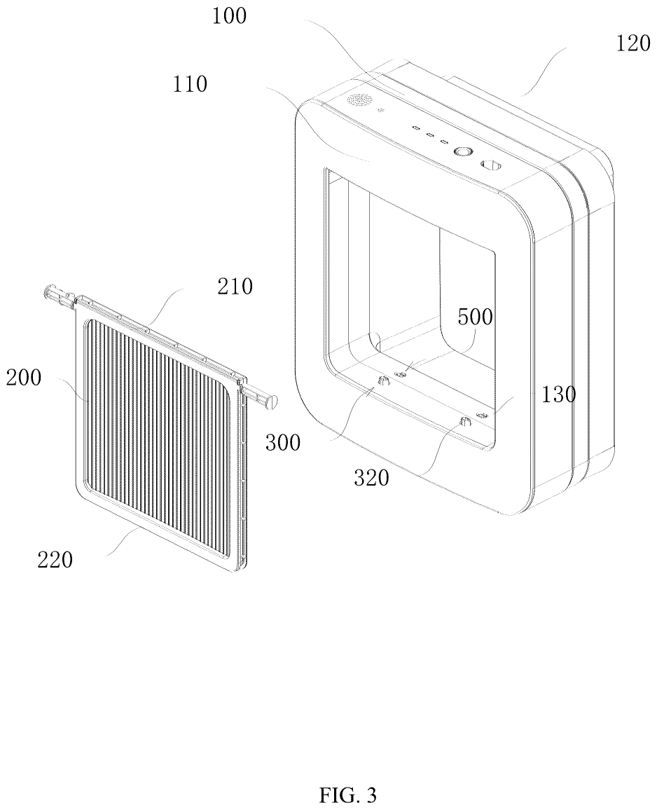

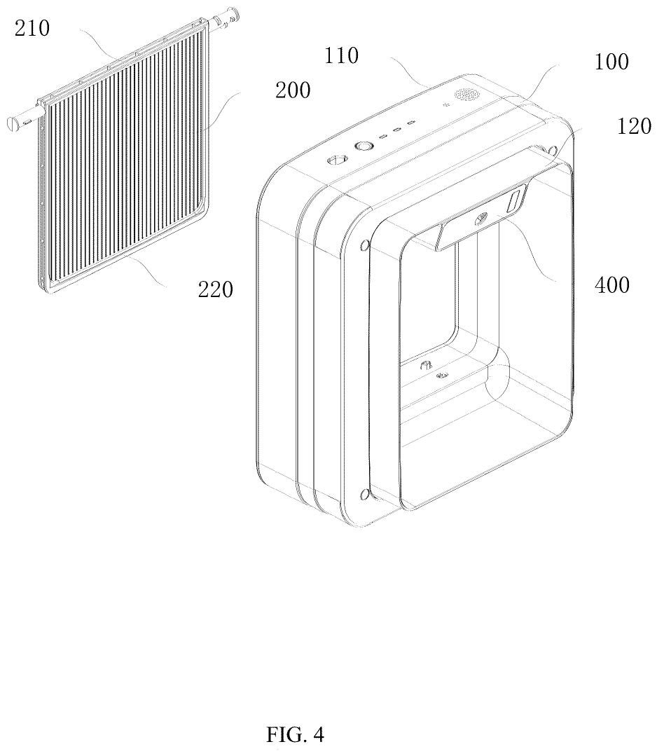

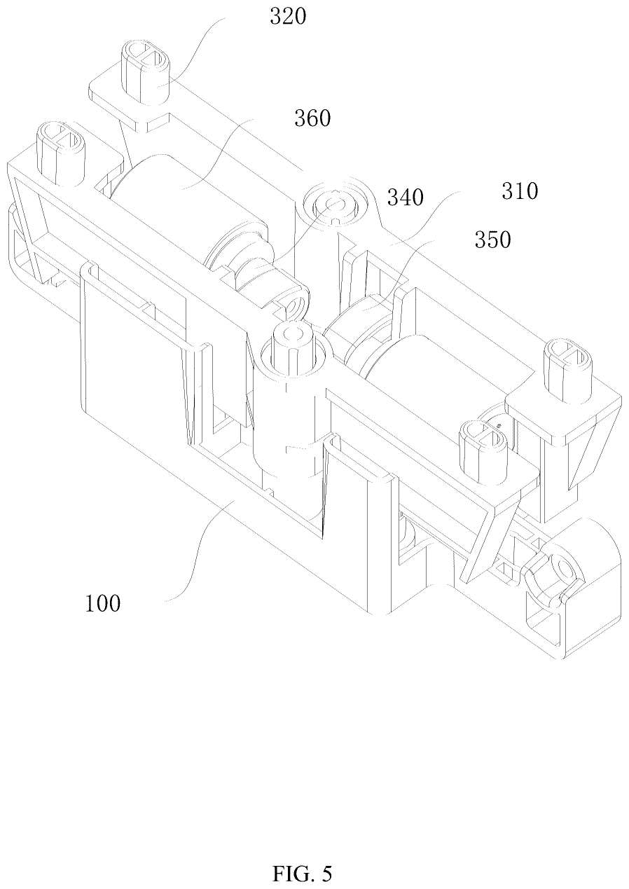

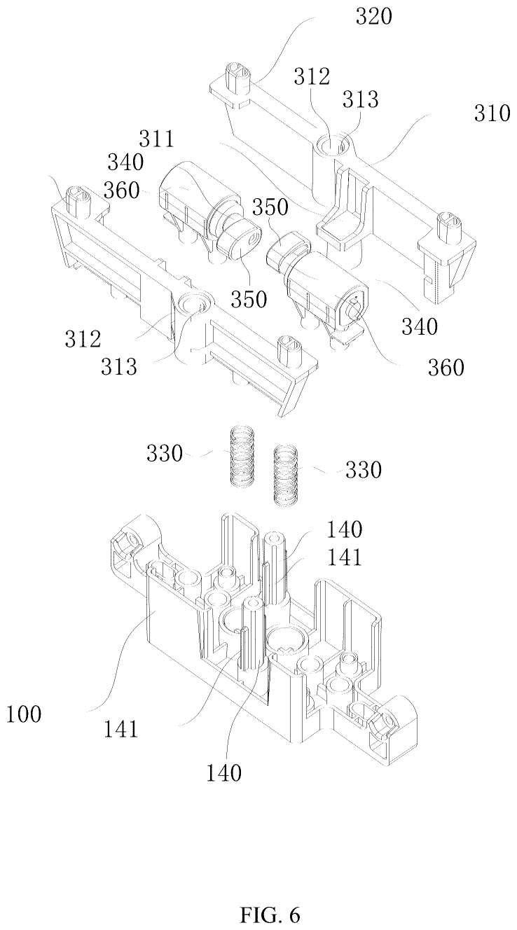

As shown in FIGS. 1 to 6, a pet door with locking mechanisms includes: a door frame 100, a door body 200, and a first locking mechanism 300.

The door frame 100 including an inner portion 110, and the door frame 100 is provided with a locking hole 130.

The door body 200 includes a rotating side 210 and a limiting side 220; the door body 200 is rotatably connected to the door frame 100 via the rotating side 210; the door body 200 is located between the inner portion 110 and the outer portion 120; the door body 200 may rotate towards the inner portion 110 or the outer portion 120; and the locking hole 130 is arranged between the inner portion 110 and the door body 200, and between the outer portion 120 and the door body 200.

The first locking mechanism 300 is arranged on the door frame 100 and located between the inner portion 110 and the door body 200; the first locking mechanism 300 includes a locking base 310 and a locking pin 320; the locking base 310 is located in the door frame 100 and is liftable relative to the door frame 100; and the locking pin 320 is connected to the locking base 310 and is extendable out of or retractable into the locking hole 130.

Specifically, when the locking pin 320 of the first locking mechanism 300 extends out of the locking hole 130, the locking pin 320 of the first locking mechanism 300 may come into contact with the limiting side 220 to restrict rotation of the door body 200 towards the inner portion 110; and when the locking pin 320 of the first locking mechanism 300 retracts into the locking hole 130, the door body 200 can freely rotate towards the inner portion 110.

Specifically, the extension or retraction of the locking pin 320 out of or into the locking hole 130 may be controlled manually or automatically, which is not specifically limited here.

In this embodiment, the first locking mechanism 300 restricts the rotation of the door body 200 towards the inner portion 110, and the extension or retraction of the locking pin 320 out of or into the locking hole 130 is controlled manually or automatically, which is specifically limited here, thereby locking the open or closed state of the pet door to restrict the entry of outside pets.

As shown in FIGS. 1 to 6, based on the embodiment described above, the first locking mechanism 300 further includes a drive element; the drive element is connected to the door frame 100; the locking base 310 is connected to the drive element; and the drive element may drive lifting of the locking base 310.

As shown in FIGS. 1 to 6, based on the embodiment described above, the first locking mechanism 300 further includes a reset spring 330; the reset spring 330 has one end in contact with the door frame 100 and the other end in contact with the locking base 310; and the reset spring 330 pushes the locking base 310 and drives the locking pin 320 to extend out of the locking hole 130.

In this embodiment, the reset spring 330 pushes the locking base 310 and drives the locking pin 320 to extend out of the locking hole 130. In this way, under normal circumstances, the locking pin 320 may come into contact with the limiting side 220 to restrict the rotation of the door body 200 towards the inner portion 110 or the outer portion 120, implementing safety protection to restrict the entry of outside pets or the escape of pets from home.

As shown in FIGS. 1 to 6, based on the embodiment described above, the locking base 310 is provided with a pressing plate 311; the drive element includes a rotation shaft 340 and an eccentric wheel 350; the rotation shaft 340 is fixed relative to the door frame 100 and is rotatable around a rotation axis thereof; the eccentric wheel 350 is connected to the rotation shaft 340; a bottom portion of the eccentric wheel 350 is in contact with the pressing plate 311; and the pressing plate 311 is located between the eccentric wheel 350 and the reset spring 330.

Specifically, the rotation of the rotating shaft 340 around its own axis may be controlled manually or automatically, which is not specifically limited here.

In this embodiment, the pressing plate 311 is located between the eccentric wheel 350 and the reset spring 330. In this way, when pushing the locking base 310, the reset spring 330 becomes tightly butted against the eccentric wheel 350, and rotates along with the rotation shaft 340 around the axis of the rotation shaft to drive rotation of the eccentric wheel 350 and to cause the locking base 310 to reciprocate linearly via the pressing plate 311, thereby allowing the locking pin 320 to extend out of or retract into the locking hole 130.

As shown in FIGS. 1 to 6, based on the embodiment described above, the drive element further includes a motor 360; the motor 360 is connected to the door frame 100; the rotation shaft 340 is connected to an output shaft of the motor 360; and the motor 360 may drive rotation of the rotation shaft 340.

As another alternative (not shown), the drive element further includes an electric cylinder; the electric cylinder is connected to the door frame 100; the locking base 310 is connected to an output shaft of the electric cylinder; and the electric cylinder may drive lifting of the locking base 310.

In this embodiment, the rotation shaft 340 is fixedly connected to the output shaft of the motor 360 and the motor 360 may drive the rotation shaft 340 to rotate, thereby achieving automatic control of the rotation shaft 340.

As shown in FIGS. 1 to 6, based on the embodiment described above, the door frame 100 is further provided with a guide post 140; the locking base 310 is provided with a guide hole 312; and the guide post 140 is slidably connected to the guide hole 312 to enable the locking base 310 to be liftably connected to the door frame 100.

In this embodiment, the guide post 140 is slidably connected to the guide hole 312 to enable the locking base 310 to be liftably connected to the door frame 100, thereby guiding the lifting of the locking base 310 relative to the door frame 100, such that the locking pin 320 is restricted in movement direction and is caused to align to the locking hole 130 all the time.

As shown in FIGS. 1 to 6, based on the embodiment described above, the guide post 140 is provided with a limiting block 141; the locking base 310 is further provided with a limiting slot 313; the limiting slot 313 is communicated to the guide hole 312; and the limiting block 141 is located in the limiting slot 313 and is movable in a length direction of the limiting slot 313.

In this embodiment, the limiting block 141 is located in the limiting slot 313 and may move in the length direction of the limiting slot 313, thereby assisting and guiding the lifting of the locking base 310 relative to the door frame 100, and at the same time, the limiting block 141 may come into contact with the limiting slot 313 to limit the movement range of the locking base 310.

As shown in FIGS. 1 to 6, based on the embodiment described above, the door frame 100 further includes an outer portion 120; the door body 200 is located between the inner portion 110 and the outer portion 120; and the door body 200 is rotatable towards the inner portion 110 and the outer portion 120.

Specifically, a second locking mechanism 500 is further included. The second locking mechanism arranged on the door frame 100 and located between the outer portion 120 and the door body 200, and the second locking mechanism 500 has a structure the same as that of the first locking mechanism 300.

More specifically, when the locking pin 320 of the second locking mechanism 500 extends out of the locking hole 130, the locking pin 320 of the second locking mechanism 500 may come into contact with the limiting side 220 to restrict rotation of the door body 200 towards the outer portion 120; and when the locking pin 320 of the second locking mechanism 500 retracts into the locking hole 130, the door body 200 may freely rotate towards the outer portion 120.

In this embodiment, the second locking mechanism 500 restricts the rotation of the door body 200 towards the outer portion 120, and the extension or retraction of the locking pin 320 out of or into the locking hole 130 is manually or automatically controlled, such that the open or closed state of the pet door can be locked to restrict the escape of pets from home.

As shown in FIGS. 1 to 6, based on the embodiment described above, a remote control system (not shown in the figures) is further included. The remote control system is configured to be communicationally connected to the motor 360 of the second locking mechanism 500, and is configured for controlling operation of the motor 360 of the second locking mechanism 500.

Specifically, the remote control system may be application software on a mobile phone.

In this embodiment, the opening, closing and locking of the pet door towards the outer portion 120 can be managed by presetting the access control period and the free period by means of the remote control system, and at the same time, the motor 360 of the second locking mechanism 500 can be temporarily controlled by means of the remote control system to cause the locking pin 320 to extend out of or retract into the locking hole 130.

As shown in FIGS. 1 to 6, based on the embodiment described above, a pet face recognition system 400. The pet face recognition system 400 is connected to the door frame 100 and located on the outer portion 120; and the pet face recognition system 400 is electrically connected to the motor 360, and is configured for recognizing a pet face to control operation of the motor 360.

In this embodiment, the locking of the opening and closing of the pet door towards the inner portion 110 can be managed by means of the pet face recognition system 400.

As shown in FIGS. 1 to 6, a method for controlling a pet door involves the pet door with the locking mechanisms as described. The method includes:
An access control period and a free period are scheduled at the remote control system. In the access control period, the remote control system automatically controls the motor 360 of the second locking mechanism 500 to cause the locking pin 320 to extend out of the locking hole 130, thereby restricting rotation of the door body 200 towards the outer portion 120. In the free period, the remote control system automatically controls the motor 360 of the second locking mechanism 500 to cause the locking pin 320 to retract into the locking hole 130, thereby allowing for free rotation of the door body 200 towards the outer portion 120.

Temporary control is performed at the remote control system to control the motor 360 of the second locking mechanism 500 to cause the locking pin 320 to extend out of or retract into the locking hole 130.

In this embodiment, the locking of the opening and closing of the pet door towards the outer portion 120 can be managed by presetting the access control period and the free period by means of the remote control system, and at the same time, the motor 360 of the second locking mechanism 500 can be temporarily controlled by means of the remote control system to cause the locking pin 320 to extend out of or retract into the locking hole 130.

As shown in FIGS. 1 to 6, based on the embodiment described above, a pet face recognition system 400 is further included. The pet face recognition system 400 is connected to the door frame 100 and located on the outer portion 120. The pet face recognition system 400 is electrically connected to the motor 360, and is configured for recognizing a pet face to control operation of the motor 360. The pet face recognition system 400 is communicationally connected to the remote control system. The remote control system is communicationally connected to the motor 360 of the first locking mechanism 300, and is configured for controlling operation of the motor 360 of the first locking mechanism 300.

The method further includes the following.

A known pet face is registered in the remote control system, and when the pet face recognition system 400 recognizes an unfamiliar pet face, the pet face recognition system 400 automatically controls the motor 360 of the first locking mechanism 300 to cause the locking pin 320 to extend out of the locking hole 130 to restrict rotation of the door body 200 towards the inner portion 110; and when the pet face recognition system 400 recognizes the known pet face, the pet face recognition system 400 automatically controls the motor 360 of the first locking mechanism 300 to cause the locking pin 320 to retract into the locking hole 130 to allow for free rotation of the door body 200 towards the inner portion 110.

Temporary control is performed at the remote control system to control the motor 360 of the second locking mechanism 500 to cause the locking pin 320 to extend out of or retract into the locking hole 130.

In this embodiment, the opening, closing and locking of the pet door towards the inner portion 110 can be managed by means of the pet face recognition system 400.

It is also worth noting here that the remote control system and the pet face recognition system 400 are linked, such that the known pet face can be registered or deleted by means of the remote control system, thereby adjusting the pet face recognition system 400 in real time. At the same time, the motor 360 of the first locking mechanism 300 can be temporarily controlled by means of the remote control system to cause the locking pin 320 to extend out of or retract into the locking hole 130.

What is claimed is:

1. A pet door with locking mechanisms, comprising:
a door frame comprising an inner portion, wherein the door frame is provided with a locking hole;
a door body comprising a rotating side and a limiting side, wherein the door body is rotatably connected to the door frame via the rotating side and is rotatable towards the inner portion, and the locking hole is located between inner portion and the door body;
a first locking mechanism arranged on the door frame and located between the inner portion and the door body, wherein the first locking mechanism comprises a locking base and a locking pin, the locking base is located in the door frame and is liftable relative to the door frame, and the locking pin is connected to the locking base and is extendable out of or retractable into the locking hole;
when the locking pin extends out of the locking hole, the locking pin can come into contact with the limiting side to restrict rotation of the door body towards the inner portion; and when the locking pin retracts into the locking hole, the door body can freely rotate towards the inner portion.

2. The pet door with the locking mechanisms according to claim 1, wherein the first locking mechanism further comprises a drive element; the drive element is connected to the door frame; the locking base is connected to the drive element; and the drive element can drive lifting of the locking base.

3. The pet door with the locking mechanisms according to claim 2, wherein the first locking mechanism further comprises a reset spring; the reset spring has one end in contact with the door frame and the other end in contact with the locking base; and the reset spring pushes the locking base and drives the locking pin to extend out of the locking hole.

4. The pet door with the locking mechanisms according to claim 3, wherein the locking base is provided with a pressing plate; the drive element comprises a rotation shaft and an eccentric wheel; the rotation shaft is fixed relative to the door frame and is rotatable around a rotation axis thereof; the eccentric wheel is connected to the rotation shaft; a bottom portion of the eccentric wheel is in contact with the pressing plate; and the pressing plate is located between the eccentric wheel and the reset spring.

5. The pet door with the locking mechanisms according to claim 4, wherein the drive element further comprises a motor; the motor is connected to the door frame; the rotation shaft is connected to an output shaft of the motor; and the motor can drive rotation of the rotation shaft.

6. The pet door with the locking mechanisms according to claim 2, wherein the drive element further comprises an electric cylinder; the electric cylinder is connected to the door frame; the locking base is connected to an output shaft of the electric cylinder; and the electric cylinder can drive lifting of the locking base.

7. The pet door with the locking mechanisms according to claim 1, wherein the door frame is further provided with a guide post; the locking base is provided with a guide hole; and the guide post is slidably connected to the guide hole to enable the locking base to be liftably connected to the door frame.

8. The pet door with the locking mechanisms according to claim 7, wherein the guide post is provided with a limiting block; the locking base is further provided with a limiting slot; the limiting slot is communicated to the guide hole; and the limiting block is located in the limiting slot and is movable in a length direction of the limiting slot.

9. The pet door with the locking mechanisms according to claim 2, wherein the door frame further comprises an outer portion; the door body is located between the inner portion and the outer portion; and the door body is rotatable towards the inner portion or the outer portion.

10. The pet door with the locking mechanisms according to claim 9, further comprising a second locking mechanism arranged on the door frame and located between the outer portion and the door body, wherein the second locking mechanism has a structure the same as that of the first locking mechanism;
when a locking pin of the second locking mechanism extends out of a locking hole, the locking pin of the second locking mechanism can come into contact with the limiting side to restrict rotation of the door body towards the outer portion; and when the locking pin of the second locking mechanism retracts into the locking hole, the door body can freely rotate towards the outer portion.

11. The pet door with the locking mechanisms according to claim 10, further comprising a remote control system, wherein the remote control system is configured to be communicationally connected to a drive element of the second locking mechanism, and is configured for controlling operation of the drive element of the second locking mechanism.

12. The pet door with the locking mechanisms according to claim 9, further comprising a pet face recognition system, wherein the pet face recognition system is connected to the door frame and located on the outer portion; and the pet face recognition system is communicationally connected to the drive element of the first locking mechanism, and is configured for recognizing a pet face to control operation of the drive element.

13. A method for controlling a pet door, comprising the pet door with the locking mechanisms according to claim 11, wherein the method comprises:
scheduling an access control period and a free period at the remote control system, wherein in the access control period, the remote control system automatically controls the drive element of the second locking mechanism to cause the locking pin to extend out of the locking hole, thereby restricting rotation of the door body towards the outer portion, and in the free period, the remote control system automatically controls the drive element of the second locking mechanism to cause the locking pin to retract into the locking hole, thereby allowing for free rotation of the door body towards the outer portion; and
performing temporary control at the remote control system to control the drive element of the second locking mechanism to cause the locking pin to extend out of or retract into the locking hole.

14. The method for controlling the pet door according to claim 13, wherein a pet face recognition system is further comprised; the pet face recognition system is connected to the door frame and located on the outer portion; the pet face recognition system is electrically connected to the drive element, and is configured for recognizing a pet face to control operation of the drive element; the pet face recognition system is communicationally connected to the remote control system; the remote control system is communicationally connected to the drive element of the first locking mechanism, and is configured for controlling operation of the drive element of the first locking mechanism; and
the method further comprises:
registering a known pet face in the remote control system, and when the pet face recognition system recognizes an unfamiliar pet face, automatically controlling, by the pet face recognition system, the drive element of the first locking mechanism to cause the locking pin to extend out of the locking hole to restrict rotation of the door body towards the inner portion; when the pet face recognition system recognizes the known pet face, automatically controlling, by the pet face recognition system, the drive element of the first locking mechanism to cause the locking pin to retract into the locking hole to allow for free rotation of the door body towards the inner portion; and
performing temporary control at the remote control system to control the drive element of the second locking mechanism to cause the locking pin to extend out of or retract into the locking hole.
